(19) United States
(12) Patent Application Publication
(10) Pub. No.: US 2026/0346070 A1
(43) Pub. Date: Nov. 5, 2026

(54) TRIGGER MODULE AND SPRINKLER

(71) Applicant: Haiping Jiang, Shaoxing (CN)

(72) Inventor: Haiping Jiang, Shaoxing (CN)

(21) Appl. No.: 19/115,456

(22) PCT Filed: Oct. 10, 2023
(86) PCT No.: PCT/CN2023/123778

§ 371 Date: Mar. 26, 2025

(30) Foreign Application Priority Data
Mar. 29, 2023 (CN) 202310323605.3
Sep. 14, 2023 (CN) 202311192597.X
Sep. 25, 2023 (CN) 202311247004.5
Oct. 7, 2023 (CN) 202311283532.6

(51) Int. Cl. A62C 37/12; G01K 11/00

(52) U.S. Cl. CPC A62C 37/12; G01K 11/00

(57) ABSTRACT

A trigger module and a sprinkler, belonging to the field of firefighting equipment technologies are described. The trigger module is fitted on a base body of the sprinkler. The trigger module includes: a trigger base, where two sets of trigger bases are disposed, and the two sets of trigger bases form an outer contour prototype of the trigger module; and a trigger member, where two ends of the trigger member are respectively connected to the two sets of trigger bases; or the trigger member abuts between the two sets of trigger bases, to limit the two sets of trigger bases from moving toward each other, where when the trigger member is in a triggering state, the two sets of trigger bases move toward each other, to make an outer contour of the trigger module shrink. A technical effect that the sprinkler remains stable operation is achieved.

### TECHNICAL FIELD

The present invention relates to the field of firefighting equipment technologies, and in particular, to a trigger module and a sprinkler.

### BACKGROUND

At present, in a sprinkler structure, a vertical trigger member abuts against a sealing module, and the trigger member is usually a temperature-sensing glass bulb. In this structure, the temperature-sensing glass bulb bears a large force.

The temperature-sensing glass bulb can bear the foregoing force in a small-aperture sprinkler. However, in a large-aperture sprinkler, a force-bearing capacity of the temperature-sensing glass bulb needs to be taken into consideration to maintain a stable operating state of the sprinkler.

Therefore, a technical problem in the prior art lies in how to design a large-aperture sprinkler.

### SUMMARY

Embodiments of this application provide a trigger module and a sprinkler, to resolve a technical problem of how to design a large-aperture sprinkler in the prior art, to achieve a technical effect that the sprinkler remains stable operation.

Embodiments of this application provide a trigger module, fitted on a base body of a sprinkler. The trigger module includes: a trigger base, where two sets of trigger bases are disposed, and the two sets of trigger bases form an outer contour prototype of the trigger module; and a trigger member, where two ends of the trigger member are respectively connected to the two sets of trigger bases; or the trigger member abuts between the two sets of trigger bases, to limit the two sets of trigger bases from moving toward each other, where when the trigger member is in a triggering state, the two sets of trigger bases move toward each other, to make an outer contour of the trigger module shrink.

Preferably, if the trigger member abuts between the two sets of trigger bases, the outer contour prototype of the trigger module formed by combining the two sets of trigger bases has an extension range; or the two sets of trigger bases are independent of each other, and a maximum value of a size of the outer contour of the trigger module is limited by the base body of the sprinkler.

Preferably, the trigger member adjustably abuts between the two sets of trigger bases, and an abutting size of the trigger member is adjusted to make the trigger member abut the two sets of trigger bases in a state that the size of the outer contour of the trigger module is the maximum value.

Preferably, the two sets of trigger bases are removably connected to form a constraint on the trigger bases in a first direction, and an abutting force of the trigger member on the trigger bases forms a constraint in a second direction, where the first direction and the second direction are a set of approximately opposite directions.

Preferably, the trigger base further includes a connecting portion, and the connecting portion acts on the two sets of trigger bases to limit the two sets of trigger bases from moving away from each other.

Preferably, the connecting portion and the trigger base are integrated, connecting portions of the two sets of trigger bases are interlocked, to build the extensibility of the trigger module; or the connecting portion and the trigger base are separately disposed, and the connecting portion and the trigger base are interlocked, or two sets of connecting portions are interlocked, to build the extensibility of the trigger module.

Preferably, the connecting portion is a ring-shaped body, and the connecting portion is sleeved between the two sets of trigger bases.

Preferably, one set or two sets of interlocked structures of the connecting portion of the two sets of trigger bases are disposed; and the interlocked structures are disposed in the middle, disposed on a single side or disposed on two sides in the trigger module.

Preferably, the connecting portion has a magnetic attraction capability, and the connecting portion has an attractive force on the trigger bases, or connecting portions are respectively disposed on the two sets of trigger bases, and the two connecting portions attract each other, to limit the two sets of trigger bases from moving away from each other.

Preferably, the two sets of trigger bases have a space for relative movement in a reference direction.

Preferably, the trigger member is disposed on an outer side of the trigger base; or the trigger member is disposed in the two sets of trigger bases, and a through cavity is provided in the trigger base opposite to the trigger member, and the through cavity communicates the trigger member with an external environment.

Preferably, the through cavity includes: a lateral through cavity, disposed in the middle of a side surface of the trigger base.

Preferably, the trigger member includes: a connecting plate, located between the two sets of trigger bases; and a fusible alloy, connecting the connecting plate and the trigger base; or the trigger member includes: a fusible alloy, abutting between the two sets of trigger bases; or the trigger member includes: a temperature-sensing glass bulb, transversely disposed between the two sets of trigger bases; and a fastening member, disposed on a trigger base, where the fastening member abuts against the temperature-sensing glass bulb, and the fastening member makes the temperature-sensing glass bulb abut between the two sets of trigger bases.

Preferably, the two sets of trigger bases are subjected to an external force and have a tendency to move toward each other; or the trigger module further includes an elastic member, and the elastic member acts on the trigger bases to make the two sets of trigger bases have a tendency to move toward each other.

Preferably, a connecting force-bearing surface on an outer side of the trigger base is at least partially an inclined surface, and the inclined surface makes the trigger module subjected to a component force of a force driving the outer contour to fold.

Preferably, a trigger thread is disposed on an outer side surface of the trigger base, and the trigger thread has a force-bearing inclined surface.

Preferably, the elastic member connects the two sets of trigger bases, or the elastic member abuts between the two sets of trigger bases, or the elastic member is clamped between the two sets of trigger bases; and the elastic member is in a charged state, and a force-applying direction of the elastic member on the trigger bases and a combination direction of the two sets of trigger bases are approximately the same, to make the outer contour of the trigger module have a tendency to deform or shrink.

Preferably, the trigger member and elastic member are disposed at an interval, and the trigger member and the elastic member respectively act on two opposite ends of a same trigger base.

Preferably, the trigger member is disposed at an exposure end of the trigger module, and the elastic member is disposed at an exposure opposite end of the trigger module.

Preferably, a force-applying direction of the elastic member on the trigger bases and a combination direction of the two sets of trigger bases are approximately the same.

Preferably, the elastic member is a spring, and two ends of the spring are respectively connected to the two sets of trigger bases.

A sprinkler includes: a base body, including a sealing opening, a base cavity, and a trigger substrate; a sealing module, located in the base cavity, and sealing the sealing opening; and a trigger module, where the trigger module is partially or completely located in the base cavity, the trigger module abuts against the sealing module and limits a position of the sealing module, the trigger module is connected to the trigger substrate by an outer contour, after a trigger member is triggered, the outer contour of the trigger module shrinks, and a connection between the trigger module and the trigger substrate fails to make the trigger module detached from the base cavity.

Preferably, the trigger member in the trigger module is transversely disposed relative to the base body, and the trigger member is exposed outward relative to the base cavity.

Preferably, a force-bearing surface of contact between the trigger substrate and the trigger module is an inclined surface, so that a force of the trigger substrate on the trigger module may be divided into a first component force, a direction of the first component force is from a trigger base to a center of the trigger module, and the first component force makes the outer contour of the trigger module have a tendency to fold.

Preferably, a balance module is disposed between the sealing module and the trigger module, the balance module and the sealing module contact at a central point, and the balance module makes the trigger module apply a pressure to the sealing module.

Preferably, the balance module includes: a balance plate, being in contact with the trigger module; and a second bulb body, disposed on the balance plate, and being in contact with the sealing module, where the second bulb body makes the balance module and the sealing module contact at a central point; or the balance module includes: a balance plate, including a plate main body and a plate body protrusion, where the plate body protrusion is located at a central position of the plate main body, the plate body protrusion is convex outward relative to the plate main body, the plate main body and the trigger module are in contact, and the plate body protrusion and the sealing module are in contact.

Preferably, the balance module and the base body are movably connected, and in a first state, the balance module is located in the base cavity, and the balance module is used for bearing the pressure between the trigger module and the sealing module; and in a second state, the balance module is located outside the base cavity, and the balance module is used as a water distribution tray for water distribution.

Preferably, the sprinkler further includes: a water distribution tray, where the water distribution tray is disposed between the sealing module and the balance module, and the water distribution tray abuts against or is connected to the sealing module; or the water distribution tray is disposed on an outer side of the base cavity, and the water distribution tray is connected to the base body by arranging a connecting arm.

A sprinkler includes a base body, a sealing module, and a trigger module, and the sealing module seals a sealing opening in the base body; the trigger module includes two trigger bases combined together, two sets of trigger bases are combined to form a prototype of the trigger module, and the two sets of trigger bases are relatively movable in a reference direction; and the sprinkler further includes: a balance module, located between the sealing module and the trigger module, and separately contacting the sealing module and the trigger module, where the balance module is tiltable relative to the trigger module; and an opposite protrusion is disposed on at least one of the balance module and the trigger base at a contact surface between the two, and the protrusion and the tiltable balance module make the two sets of trigger bases adjustable in the reference direction.

Preferably, trigger threads are separately disposed on the two sets of trigger bases, and the trigger module is spirally connected to the base body through the trigger threads on the two sets of trigger bases.

Preferably, a concave groove is provided in an exposure opposite end of the trigger module corresponding to the balance module, to make a contact portion of the exposure opposite end an opposite protrusion.

Preferably, the protrusion is a third bulb body, the third bulb body is disposed on the trigger base or the balance module, and the third bulb body is rotatable in the trigger base or the balance module.

Preferably, the protrusion is disposed at a periphery of the contact surface between the balance module and the trigger base.

Preferably, the balance module includes: a balance plate, being in contact with the trigger base; and a second bulb body, disposed between the sealing module and the balance plate, where the second bulb body makes the balance plate freely tiltable.

A sprinkler includes a base body having a base cavity, a sealing module located in the base cavity, a balance module located in the base cavity, and a trigger module located in the base cavity, where the sealing module seals a sealing opening in the base body, and the trigger module abuts the sealing module through the balance module; and the sprinkler further includes: a water distribution module, including: a water distribution tray, disposed in the base cavity, where the water distribution tray and the sealing module are integrally connected, and the balance module acts on the water distribution tray or the sealing module; or the water distribution tray is disposed between the sealing module and the balance module, and the balance module, the water distribution tray, and the sealing module sequentially abut; or the water distribution tray is disposed between the sealing module and the balance module, a avoidance channel is provided in the water distribution tray, and the balance module passes through the avoidance channel to act on the sealing module; and a guide rod, where the guide rod and the base body are movably connected, or the guide rod is extensible, and the guide rod and the water distribution tray are connected, so that after the trigger module is triggered, the water distribution tray protrudes outside the base body.

Preferably, the trigger module includes two trigger bases combined together, and the two sets of trigger bases are relatively movable in a reference direction; and trigger threads are separately disposed on the two sets of trigger bases, and the trigger module is spirally connected to the base body through the trigger threads on the two sets of trigger bases.

Preferably, the balance module includes: a balance plate, being in contact with the trigger module; and a second bulb body, disposed on the balance plate, and being in contact with the sealing module, where the second bulb body makes the balance module and the sealing module contact at a central point; or the balance module includes: a balance plate, including a plate main body and a plate body protrusion, where the plate body protrusion is located at a central position of the plate main body, the plate body protrusion is convex outward relative to the plate main body, the plate main body and the trigger module are in contact, and the plate body protrusion and the sealing module are in contact.

Preferably, a spacing is provided between the sealing module and the water distribution module; a vertical rod is disposed in the spacing, and the vertical rod respectively contacts the sealing module and the water distribution module, to transfer a force of the water distribution module on the sealing module; and if the avoidance channel is provided in the water distribution module and the balance module acts on the sealing module, the vertical rod respectively contacts the sealing module and the balance module.

Preferably, the vertical rod fits a first bulb body, and the first bulb body is disposed on a side of the vertical rod opposite to the sealing module, or the first bulb body is disposed on a side of the vertical rod opposite to the balance module/the water distribution module.

Preferably, the balance module is tiltable relative to the trigger module; and an opposite protrusion is disposed on at least one of the balance module and the trigger base at a contact surface between the two, and the protrusion and the tiltable balance module make the two sets of trigger bases adjustable in the reference direction.

Preferably, the protrusion is a third bulb body, the third bulb body is disposed on the trigger base or the balance module, and the third bulb body is rotatable in the trigger base or the balance module.

Preferably, a clamp ring is disposed in the base cavity, and the base body and the guide rod are movably connected by the clamp ring; or a connecting end fitting the guide rod is disposed on an inner wall of the base cavity.

Preferably, the base body is separately disposed, the base body includes a first base body and a second base body, and a connecting end fitting the guide rod is disposed in the second base body.

A sprinkler includes a base body having a base cavity, a sealing module located in the base cavity, and a trigger module located in the base cavity, where the sealing module seals a sealing opening in the base body, the trigger module includes two sets of trigger bases, and the two sets of trigger bases are combined to form a prototype of the trigger module; and the trigger module is connected to the base body by an outer contour, the trigger module abuts against the sealing module and limits a position of the sealing module, and an outer side surface of the trigger module is at least partially located in the base cavity; and a penetrating communication groove is provided in the base body relative to the trigger module, and the communication groove exposes the outer side surface of the trigger module located in the base cavity, where a fastening member is disposed on the outer side surface of the trigger module relative to the communication groove, the fastening member is located in the communication groove, and the fastening member and a fastening groove fit to limit rotation of the trigger module relative to the base body.

Preferably, the fastening groove is provided in the outer side surface of the trigger module opposite to the fastening member.

Preferably, an opening is further provided in an exposure end of the communication groove facing the trigger module, and the opening makes it possible to sleeve the communication groove, so that when the communication groove is used as a buckling opening, the sprinkler can be driven to rotate.

A sprinkler is provided, where an outer side surface of a trigger module is at least partially exposed outside a base cavity, the sprinkler is further provided with a cover body, and the cover body includes: an inner cover, where an inner cover claw is disposed in the inner cover, two sets of inner cover claws are clamped at an exposed part of the trigger module opposite to the base cavity, a force-applying direction of the inner cover claws on the trigger module is a first direction; and the trigger module includes two sets of trigger bases, the two sets of trigger bases are combined to form a prototype of the trigger module, a movement direction in which the two sets of trigger bases fold to each other is a second direction, and the first direction and second direction are approximately same, to make an outer contour of the trigger module have a tendency to fold.

Preferably, the cover body further includes an external cover, where an inner cavity is provided in the middle of the external cover, a plurality of external cover claws are disposed at an edge of the inner cavity, the plurality of external cover claws form a clamping cavity of the external cover clamped at an outer side surface of a base body, a contour size of the inner cover is smaller than a size of the inner cavity of the external cover, and the inner cover is approximately located in a projection of the clamping cavity of the external cover in an axial direction of the sprinkler.

Preferably, a convex limiting block is disposed at the edge of the inner cavity of the external cover, and the limiting block limits a movement range of the external cover in the axial direction of the sprinkler.

The foregoing one or more technical solutions in the embodiments of this application at least have the following one or more technical effects:
1. In this application, the trigger member does not directly abut against the sealing module, and the trigger member is used for transversely limiting outer contours of the two sets of trigger bases, to make the entire trigger module maintain one fastening type, so that the trigger module and the trigger substrate of the base body can be stably connected. Based on the stable connection of the trigger module, it is implemented that the trigger bases and the trigger substrate bear most of the vertical pressure in a firefighting piping network, so that a bearing pressure on the trigger member is greatly reduced. Therefore, in the sprinkler design, it is not necessary to deliberately consider the problem of the aperture of the trigger member, and the technical problem of how to design a large-aperture sprinkler in the prior art is resolved. A technical effect that the sprinkler remains stable operation is achieved.

### BRIEF DESCRIPTION OF THE DRAWINGS

FIG. 1 is a schematic structural front cross-sectional view of a sprinkler;

FIG. 2 is a schematic diagram of a force relationship between a trigger module and trigger substrate;

FIG. 3 is a schematic structural bottom view of a trigger module in a trigger substrate;

FIG. 4 is a schematic structural bottom view of various variant structures of a trigger module;

FIG. 5 is a schematic structural bottom view of two other variant structures of a trigger module;

FIG. 6 is a schematic structural bottom view of six other variant structures of a trigger module;

FIG. 7 is a schematic structural diagram when a connecting portion in a trigger module is an independent part;

FIG. 8 is a schematic structural bottom view of four other variant structures of a trigger module;

FIG. 9 is a schematic structural front cross-sectional view of another sprinkler;

FIG. 10 is a schematic structural front cross-sectional view of a sprinkler after being triggered;

FIG. 11 is a schematic diagram of a trigger base being folded and further unfolded;

FIG. 12 is a schematic structural top view of two other variant structures of a trigger module and a schematic connection front view with a balance module;

FIG. 13 is a schematic structural front cross-sectional view of three types of a balance module;

FIG. 14 is a schematic connection diagram of a water distribution module between a balance module and a trigger module;

FIG. 15 is a schematic structural front cross-sectional view of a base body;

FIG. 16 is schematic structural front and bottom view of another sprinkler; and

FIG. 17 is a schematic structural front view of another sprinkler.

### DETAILED DESCRIPTION

The serial numbers assigned to the components herein, such as “first”, “second”, and the like, are used only to distinguish the objects described, and do not have any sequential or technical meaning. The terms “connection” and “coupling” in this application include direct and indirect connection (coupling) unless otherwise specified. In the description of this application, it should be understood that orientation or position relationships indicated by the terms such as “up”, “down”, “front”, “behind”, “left”, “right”, “vertical”, “horizontal”, “top”, “bottom”, “inside”, “outside”, “clockwise”, and “counterclockwise” are based on orientation or position relationships shown in the accompanying drawings, and are used only for ease and brevity of illustration and description, rather than indicating or implying that the mentioned apparatus or component must have a particular orientation or must be constructed and operated in a particular orientation. Therefore, such terms should not be construed as limiting of this application.

In this application, unless otherwise explicitly specified or defined, the first feature being located “above” or “below” the second feature may be the first feature being in a direct contact with the second feature, or the first feature being in an indirect contact with the second feature through an intermediary. In addition, that the first feature is “above”, “over”, or “on” the second feature may indicate that the first feature is directly above or obliquely above the second feature, or may merely indicate that the horizontal position of the first feature is higher than that of the second feature. That the first feature is “below”, “under”, and “beneath” the second feature may be that the first feature is right below the second feature or at an inclined bottom of the second feature, or may merely indicate that the horizontal position of the first feature is lower than that of the second feature.

To better understand the above technical solution, the above technical solution will be described in detail below in conjunction with the accompanying drawings of the specification as well as specific implementations.

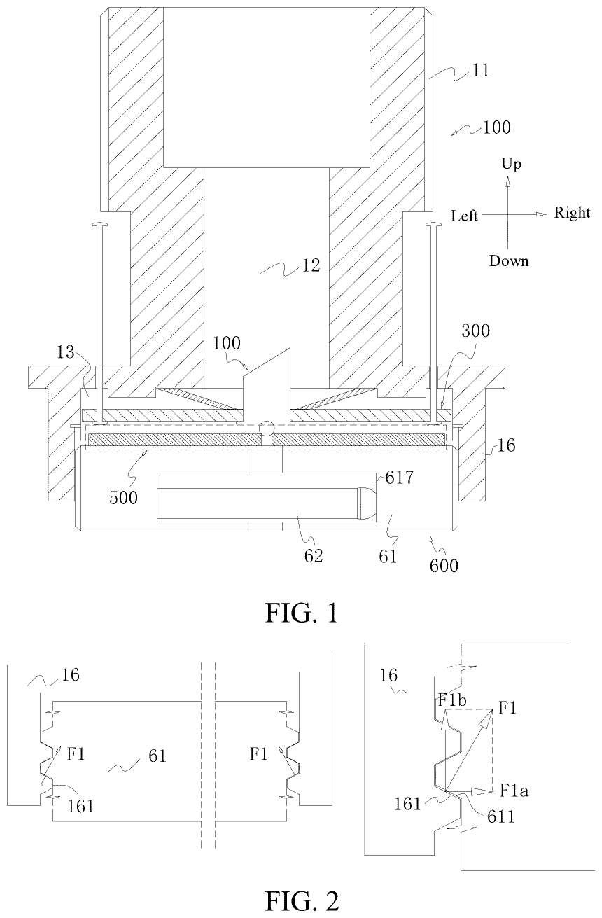

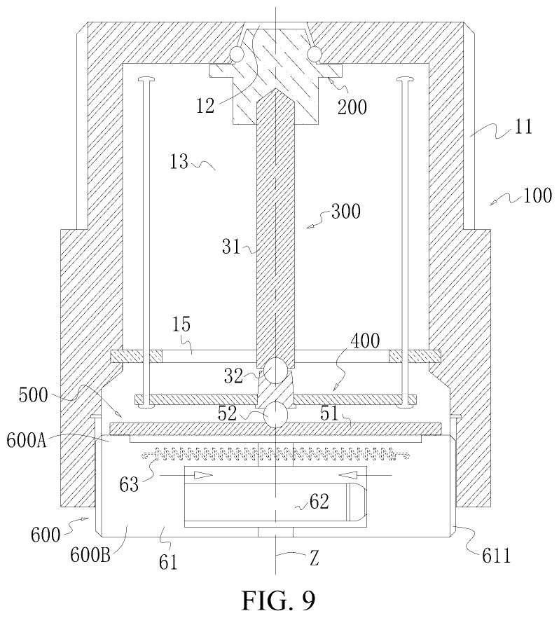

Referring to FIG. 1 and FIG. 8, this application provides a sprinkler. The sprinkler includes a base body 100, a sealing module 200, a balance module 500, and a trigger module 600. The base body 100 has a base cavity 13. The sealing module 200 is located in the base cavity 13. The trigger module 600 abuts against the sealing module 200 with the balance module 500 as an intermediate force transfer member, to make the sealing module 200 seal a sealing opening 12 on the base body 100. For the base body 100, refer to FIG. 1 and FIG. 9. The base body 100 is externally used for connecting a piping network, and is internally used as a fastening base for other parts.

The base body 100 includes an external connecting thread 11, the sealing opening 12, the base cavity 13, and a trigger substrate 16. Specifically, the external connecting thread 11 is disposed at an upper end of the base body 100, and is used for joining a firefighting piping network. Based on a connecting end structure of the firefighting piping network, the external connecting thread 11 may be an internal thread, an external thread, or directly another connecting structure (that is, the external connecting thread 11 is only a component name, and is not limited to a threaded structure) in a sealed connection form. The sealing opening 12 is located at the upper end of the base body 100. After the base body 100 is threadedly connected to the firefighting piping network, the sealing opening 12 is used as a node port for a water flow in the piping network to move outward. In other words, when the sealing opening 12 is opened, the water flow in the piping network may spray from inside the base body 100 along the sealing opening 12, to implement firefighting and fire control.

The base cavity 13 is an accommodating cavity body located in the base body 100. The base cavity 13 is in communication with the sealing opening 12. The sealing module 200 and other components (the balance module 500 and the trigger module 600 in this application) that limit the sealing module 200 are disposed in the base cavity 13. The trigger substrate 16 is another component used for connecting to and limiting the sealing module 200, or directly limits the sealing module 200. Similar to the external connecting thread 11, the trigger substrate 16 is only a component name, and is not limited to a threaded structure. If a trigger base 61 uses an insertion fit of the inclined surface and the trigger substrate 16, the trigger substrate 16 has a contact surface fitting an outer side surface of one trigger base 61.

It needs to be noted that, the base body 100 may be integrated, and a plurality of technical features are disposed on a component. Referring to FIG. 9 and FIG. 14, the base body 100 may be formed by combining a plurality of components, and a plurality of technical features are separated and disposed on the plurality of components.

For the sealing module 200, refer to FIG. 1. Under the action of a pressure, the sealing module 200 contacts and is attached to the sealing opening 12, to implement sealing. The sealing module 200 includes a sealing main body 21 and a sealing element 22. The sealing main body 21 is used for facilitating fitting with a pressure member (the pressure member is, for example, a vertical post 300, or the balance module 500). A connecting groove 212 is provided in the sealing main body 21. The connecting groove 212 may be either concave or convex, to facilitate stable fitting. A specific form of the sealing element 22, referring to FIG. 1, may be an elastic gasket form, or may be, for example, a sealing ring type shown in FIG. 9. The sealing element 22 is disposed on the sealing main body 21. Specifically, the sealing element 22 is connected to the sealing main body 21. For example, the sealing element 22 is a rubber ring. A sealing shoulder portion 211 fitting the rubber ring is disposed on the sealing main body 21. Similarly, if the sealing element 22 is a sealing gasket, a limiting structure may be disposed on the sealing main body 21.

The balance module 500, referring to FIG. 9, is used for balancing a force of the trigger module 600 on the sealing module 200. The balance module 500 is disposed between the sealing module 200 and the trigger module 600 in a contact manner. Specifically, the balance module 500 includes a balance plate 51 and a second bulb body 52. The balance plate 51 contacts the trigger base 61. The second bulb body 52 is disposed between the sealing module 200 and the balance plate 51. The second bulb body 52 makes the balance plate tiltable. It needs to be noted that, the balance module 500 and the sealing module 200 preferably contact at a central point. The contact at a central point has a concentrated force and uniform force transfer, making sealing between the sealing main body 21 and the base body 100 stable.

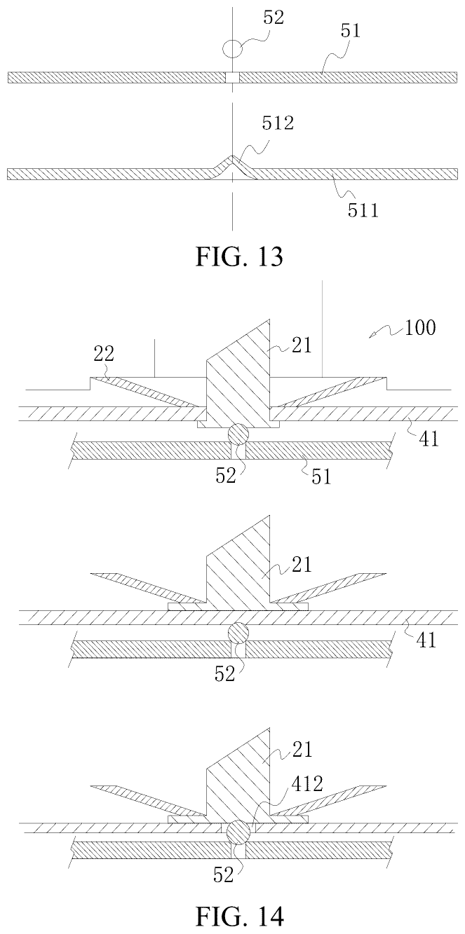

Referring to FIG. 13, the balance plate 51 is a plate body or sheet body and may be either elastic or not elastic (when the balance plate is elastic, the trigger module 600 can better tightly press the base body 100, and a threaded connection is stable). In an embodiment, the second bulb body 52 is omitted. Specifically, the balance plate 51 includes a plate main body 511 and a plate body protrusion 512. The plate body protrusion 512 is located at a center of the plate main body 511, and the plate body protrusion 512 is convex outward relative to the plate main body 511. The plate main body 511 contacts the trigger module 600, and the plate body protrusion 512 contacts the sealing module 200.

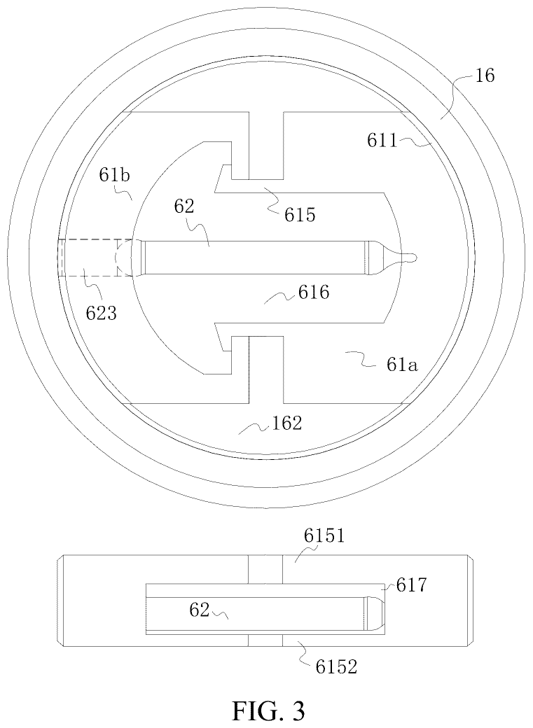

The trigger module 600, referring to FIG. 1 and FIG. 3, is used for being triggered when an environmental temperature rises to a trigger temperature. The trigger module 600 includes a trigger base 61 and a trigger member 62. Two sets of trigger bases 61 are disposed. The two sets of trigger bases 61 form an outer contour prototype of the trigger module 600. Two ends of the trigger member 62 are respectively connected to the two sets of trigger bases 61. Alternatively, the trigger member 62 abuts between the two sets of trigger bases 61. The outer contour prototype of the trigger module formed by combining the two sets of trigger bases has an extension range, and when the extension range reaches a maximum range value, the two sets of trigger bases abut and are limited. The two sets of trigger bases 61 are limited from moving toward each other. When the trigger member 62 is in a triggering state, the two sets of trigger bases 61 move toward each other, making an outer contour of the trigger module 600 shrink.

Specifically, the smallest contour of the trigger module 600 is limited by the trigger member 62. The largest contour of the trigger module 600 is limited by a direct combination between the two sets of trigger bases 61, or fitting between the two sets of trigger bases 61 and a connecting portion 615, or by the base body 100 of the sprinkler.

The folding of the trigger base 61 is mainly classified into two types of driving forms. In the first large type, a folding force is set in the trigger module 600. In the second large type, the trigger module 600 is subjected to a folding force in the sprinkler. The folding force in the second large type is further classified into two types. One type is a force from the balance module 500, and the force is resolved through an inclined surface between the trigger module 600 and the trigger substrate 16, to generate a force that drives the two sets of trigger bases 61 to approach each other. The second type is clamping of the trigger module 600 by a cover body 700, to make the trigger module 600 subjected to a centripetal clamping force.

Specifically, if a folding force is set in the trigger module 600, an elastic member 63 may be added. Two trigger bases 61 are disposed. The two sets of trigger bases 61 are combined to form a prototype of the trigger module 600. The trigger member 62 and the elastic member 63 respectively act on the two sets of trigger bases 61, to achieve stability in a non-triggering state and fast response in a triggering state of the trigger module 600. After the trigger module 600 is triggered, because the trigger member 62 deforms or fractures, under the action of the elastic member 63, the two sets of trigger bases 61 are folded to each other, and are detached from the base body 100.

Specifically, if the trigger module 600 is subjected to a folding force in the sprinkler and the force is transferred from the balance module 500, a connecting force-bearing surface on an outer side of the trigger base 61 is at least partially an inclined surface, and the inclined surface makes the trigger module 600 subjected to a component force of a force driving the outer contour to fold. Referring to FIG. 2, a pressure of one or more of a water pressure in the piping network, the sealing module 200, and the balance module 500 on the trigger module 600 makes the trigger module 600 generate a force F1, and a first component force F1a of the force is applied from the trigger base 61 toward a center of the trigger module 600, to make the outer contour of the trigger module 600 have a tendency to fold inward. It may be understood that, to make it possible for the force F1a to be resolved into the centripetal first component force F1a, an acting surface between the trigger module 600 and the trigger substrate 16 is disposed as an inclined surface. Specifically, a threaded connection may also be considered as several tilted acting surfaces. Certainly, an entire tilted acting surface is also completely feasible.

In addition to that the trigger member is fastened to the trigger base, the trigger member 62 may be movably connected to the trigger base. A form in which the trigger member 62 abuts between the two sets of trigger bases 61 is used to limit the outer contour of the trigger module 600, to make it impossible for the two sets of trigger bases 61 to fold. In addition, the connecting portion acts on the two sets of trigger bases, to make it impossible for the two sets of trigger bases 61 to extend, to eventually make the trigger module 600 stable. Specifically, in one type, the connecting portion 615 is disposed on the trigger base 61, the connecting portion and the trigger base are integrated, and connecting portions of the two sets of trigger bases are interlocked, to build the extensibility of the trigger module. In another type, the connecting portion and the trigger base are separately disposed, and the connecting portion and the trigger base are interlocked, or two sets of connecting portions are interlocked, to build the extensibility of the trigger module.

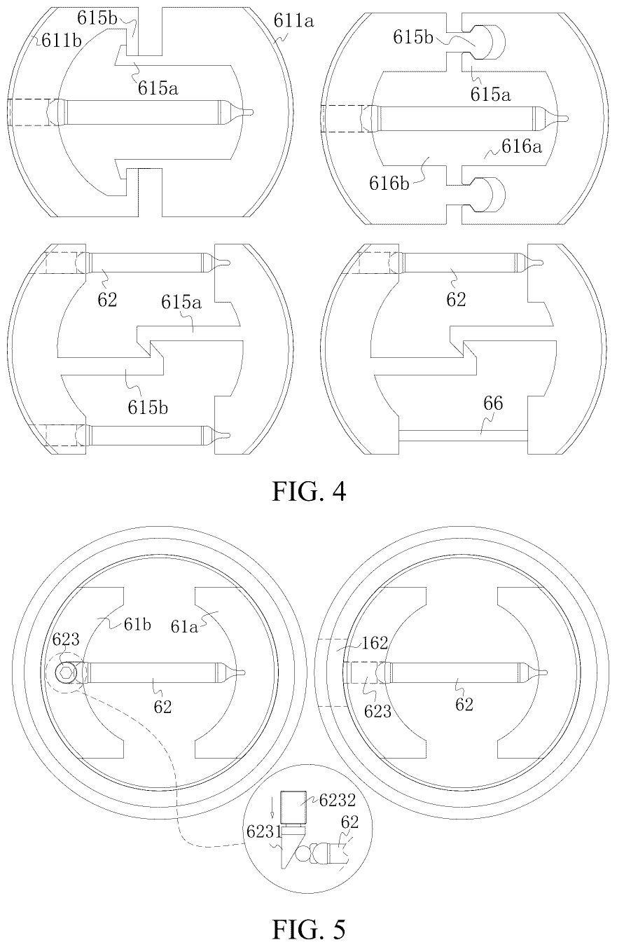

Referring to FIG. 4, the connecting portions 615 are interlocked, the two sets of trigger bases 61 are classified into a first trigger base 61a and a second trigger base 61b. The first connecting portion 615a on the first trigger base 61a and the second connecting portion 615b on the second trigger base 61b are interlocked (interlocked in this application). The interlocking form may be interlocking from outside to inside, or may be interlocking from inside to outside. The trigger member 62 is disposed in the middle of the two sets of trigger bases 61, and a fastening member 623 is disposed on the trigger base 61 to tightly hold the trigger member 62 between the two trigger bases 61. There are also various interlocking forms, interlocking on a single side, interlocking on both sides; or may be middle interlocking or interlocking on two sides, or interlocking on a single side. Preferably, the first connecting portion 615a and the second connecting portion 615b are parallel and smooth. That is, in a folding process of two trigger bases 61, the first trigger base 61a moves based on the first connecting portion 615a along a main body of the second connecting portion 615b, and the second trigger base 61b moves similarly, to guide a folding direction between the first trigger base 61a and the second trigger base 61b, so that the folding direction of the two sets of trigger bases 61 has fixed guidance, thereby increasing the triggering stability of the two sets of trigger bases 61, and avoiding jamming caused by a folding misalignment. It needs to be noted that when interlocking is required at two positions or the trigger member 62 needs to be disposed at two positions, a support member 66 may be used to replace interlocking at one position or the trigger member 62 at one position, to reduce the arrangement of the interlocking structure or the trigger member 62.

Referring to FIG. 5, the two sets of trigger bases 61 may have a form of being independent of each other, the base body 100 is used to limit an outer contour of the trigger base 61, and at the same time a temperature-sensing glass bulb is used as a position support for the two sets of trigger bases 61. Specifically, the two sets of trigger bases 61 are placed in the base cavity 13, then the trigger member 62 is placed, and the fastening member 623 is used to abut the temperature-sensing glass bulb. In addition, a component may further be disposed between the fastening member 623 and the temperature-sensing glass bulb, to better transfer a force and protect the temperature-sensing glass bulb. For example, the fastening member 623 uses a manner of a wedge block and a screw to limit a position of the trigger member 62, to protect the temperature-sensing glass bulb from damage, and balls and a spacer may further be added in the middle.

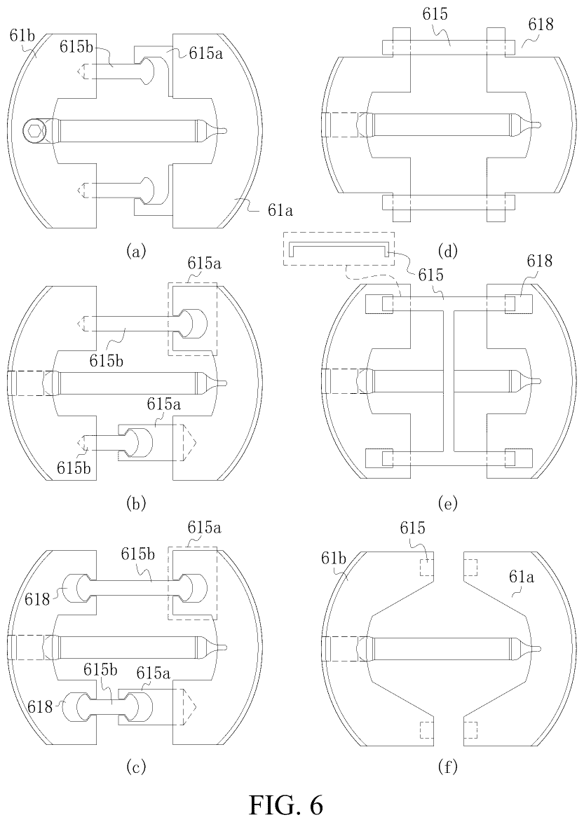

Referring to FIG. 6, the connecting portion and the trigger base are disposed in various combinations, and there are specifically various forms. In (a) in exemplary FIG. 6, the two sets of trigger bases 61 are independent, connecting portions are respectively disposed on the two sets of trigger bases 61, and the first connecting portion 615a and the second connecting portion 615b are interlocked. In (b) in exemplary FIG. 6, the first connecting portion 615a and the first trigger base 61a are integrated. In (c) in exemplary FIG. 6, the first connecting portion 615a and the second connecting portion 615b are integrated, and are respectively interlocked on the two sets of trigger bases 61. In (c) in exemplary FIG. 6, the first connecting portion 615a and the second connecting portion 615b are interlocked, and the first connecting portion 615a and the second connecting portion 615b are respectively interlocked on the two sets of trigger bases 61. In (d) in exemplary FIG. 6, a manner of clamping the connecting portion 615 may be that the trigger base 61 is limited inward from an outer side of the trigger base 61. If having an elastic force of folding inward, the connecting portion 615 may further be used as the elastic member 63. In (e) in exemplary FIG. 6, a manner of clamping the connecting portion 615 may be that a limiting cavity 618 is provided in the middle of the trigger base 61 to limit the trigger base 61, the specific connecting portion 615 hooks the limiting cavity 618 through a bent portion, and a plurality of connecting portions 615 may be independent or may be integrated. In addition, the connecting portion 615 may be a magnetic attraction member. For example, in (f) in FIG. 6, an attractive force of a connecting portion on another set of trigger bases or an attractive force between connecting portions that are respectively located at two sets of trigger bases limits the size of the outer contour of the trigger module, to limit the largest contour of the trigger module 600. It may be understood that in a magnetic attraction form, the action on the trigger base is no longer a single limitation, which further facilitates folding of the trigger base.

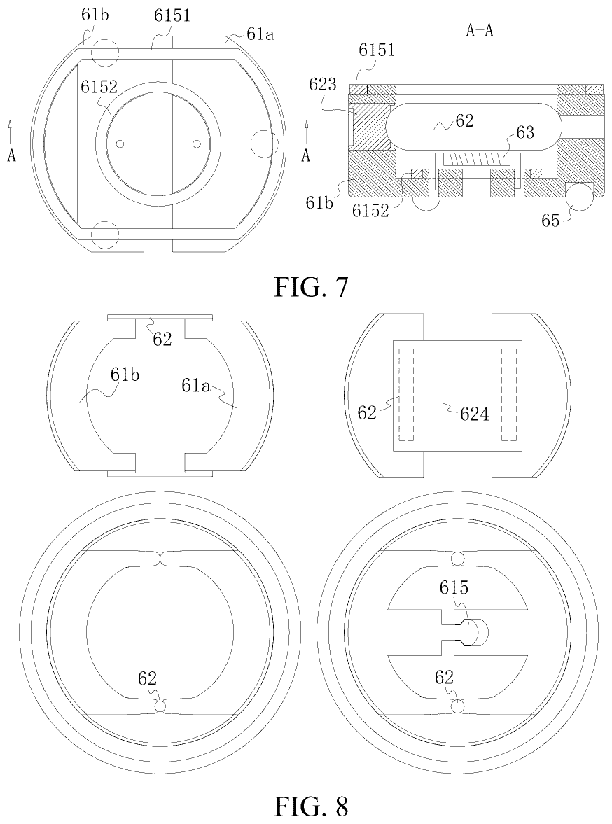

Specifically, the definition of interlocking in this application further includes the meaning of sleeving, and partial sleeving and complete sleeving both fall in the definition of interlocking in this application. For example, referring to FIG. 7, the connecting portion is a ring-shaped body (a half ring, a full ring, a half loop, or a full loop), and the ring-shaped body is sleeved on the two sets of trigger bases (the limiting cavity 618 that allows sleeving may be processed in the trigger base). The largest contour sizes of the two sets of trigger bases are limited, to facilitate fitting of the trigger member to stabilize the entire trigger module. The advantages of this structure lie in that the ring-shaped body and the two sets of fitting trigger bases are simple to process. For specific two sets of trigger bases, outer side threads may be first processed on a rod material, then the rod material is cut into two trigger bases, so that the threads of the two sets of trigger bases have a high fitting degree, to ensure a stable connection between the trigger module and the base body.

It may be understood that, a set of connecting portions 615 may be disposed, or two sets of connecting portions may be disposed (the two sets of connecting portions may be disposed separately on an upper side and a lower side of the trigger member). A limiting direction of the connecting portion 615 on the trigger base 61 is approximately same as a folding direction of the trigger base 61, to facilitate folding of the trigger base 61. The foregoing several examples may be combined at will. For example, when a clamping form of the connecting portion 615 is used, the magnetic attraction member is also used, to improve a clamping effect.

Referring to FIG. 8, when the trigger member 62 is a fusible alloy, the trigger member 62 may be connected to the trigger base 61, or the trigger member 62 may be directly connected to the two sets of trigger bases 61, or a connecting plate 624 may be added to fit the fusible alloy to connect the two sets of trigger bases 61 disposed at an interval. The connecting plate 624 may be disposed on a side surface, a bottom surface (that is, the connecting plate 624 is located in an exposed bottom surface of the sprinkler) or a top surface of the trigger base 61 (it needs to be ensured that a temperature-sensing effect of the trigger member 62 is normal). In addition, the fusible alloy may be used as one part, and is fastened between the connecting plate 624 and the trigger base 61 by another a solder or sticky substance.

In addition, the fusible alloy may be used as a filling member, filled between the two sets of trigger bases 61. A form in which the connecting portions 615 are interlocked may further be used between the two sets of trigger bases 61 to increase the stability of the trigger module 600. It needs to be noted that, referring to FIG. 4 to FIG. 6, the foregoing various types may be combined and superimposed with each other and varied to form more types. The more varied types shall also fall within the scope of protection of this application.

A structural form of the foregoing trigger module 600 is further described. If the two sets of trigger bases 61 are interlocked or outer contour/inner contour sizes of the two sets of trigger bases 61 are limited, to form a constraint in a first direction; and the trigger member 62 is filled between the two sets of trigger bases 61 to form a constraint in the second direction. The first direction and the second direction re preferably a set of approximately opposite directions, to facilitate stable limitation of the trigger member 62 on the outer contour of the trigger module 600, and also facilitate fast folding of the trigger base 61 after the trigger member 62 is triggered. For example, referring to FIG. 4, the interlocking between the two sets of trigger bases 61 limits the two sets of trigger bases 61 from separating outward (that is, the constraint in the first direction), and the action of the abutting of the trigger member 62 between the two sets of trigger bases 61 limits the two sets of trigger bases 61 from folding inward (that is, the constraint in the second direction). A constraint that limits separation between the inside and outside and a constraint that limits inward folding are applied to the two sets of trigger bases 61, to make the trigger module 600 in a stable integrated state. It is ensured that the trigger module 600 can only release a constraint and there is a deformation when the trigger member 62 breaks/melts after being triggered. Certainly, the description about the directions of the constraints in the foregoing example is only an example, and constraints in other directions are also feasible, as long as it is met that a balance is formed between two or more constraints.

For the trigger base 61, referring to FIG. 8, the connecting portion 615 and/or the base body 100 fit the trigger member 62 to limit the contour of the trigger module 600. After the trigger member 62 is triggered and fractures, the limitation of the trigger module 600 from folding inward disappears, and the two sets of trigger bases 61 fold, to achieve that a threaded connection relationship between the trigger base 61 and the base body 100 is released.

The trigger member 62 is used for fracturing or melting after temperature sensing, and may use a temperature-sensing glass bulb, or may use a fusible alloy, or a manner of a fusible alloy and an auxiliary member. For a preferred mounting position of the trigger member 62 in the trigger module 600, in a first case, an action direction of the trigger member 62 after being mounted on the two sets of trigger bases 61 and a movable direction of the two sets of trigger bases 61 after being interlocked are basically consistent, so that after the trigger member 62 is triggered, the two sets of trigger bases 61 can fold smoothly. In a second case, the trigger member 62 and the elastic member 63 are preferably disposed at an interval, and the trigger member 62 and the elastic member 63 respectively act on two ends of the same trigger base 61 in a reference direction Z, to ensure that the trigger base 61 bears a force uniformly, so that it is ensured that after the trigger member 62 is triggered, a single end of the trigger base 61 is subjected to a force and turn over. For example, the trigger member 62 is disposed at an exposure end 600A of the trigger module 600, and the elastic member 63 is disposed at an exposure opposite end 600B of the trigger module 600.

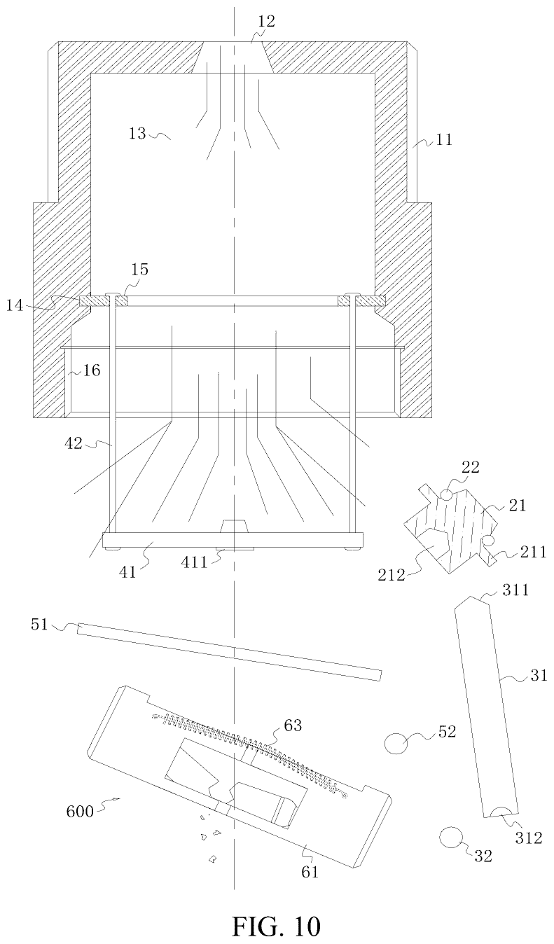

The elastic member 63, referring to FIG. 10, is used for driving the trigger base 61 to move. The elastic member 63 connects the two sets of trigger bases 61, or the elastic member 63 abuts between the two sets of trigger bases 61, or the elastic member 63 clamps the two sets of trigger bases 61; and the elastic member 63 is in a charged state, to make the outer contour of the trigger module 600 have a tendency to deform or shrink (the deformation is specifically a deformation that can be separated from the limitation of the base cavity 13). It may be understood that, a force-applying direction of the elastic member 63 on the trigger base 61 is preferably approximately the same as a combination direction of the two sets of trigger bases 61, to promote the movement of the two sets of trigger bases 61.

In an embodiment, referring to FIG. 12, the elastic member 63 is a spring. Two ends of the spring are respectively interlocked on the two sets of trigger bases 61, or two ends of the spring abut against the two sets of trigger bases 61. In another embodiment (for example, FIG. 6(e)), the elastic member 63 is used as the connecting portion 615 and is clamped on the two sets of trigger bases 61.

For the trigger module 600, in addition to the internal combination form, a connection form between the trigger module 600 and the trigger substrate 16 further needs to be considered. For this, the trigger module 600 may specifically use a threaded connection, an insertion assembly or an interlocked assembly. It may be understood that, in a spiral connection form, a thread is disposed on the outer side surface of the trigger base 61, and the two sets of trigger bases 61 make it possible for the outer contour of the trigger module 600 to be threadedly assembled. For details, refer to FIG. 9 in the specification. For example, a substrate thread is disposed on an inner side of the trigger substrate 16, a thread of the first trigger base 61a is disposed on an outer side of the first trigger base 61a, and a thread of the second trigger base 61b is disposed on an outer side of the second trigger base 61b. In the case of an insertion fitting form, the outer side surface of the trigger base 61 is an inclined surface, and the two sets of trigger bases 61 make it possible for the outer contour of the trigger module 600 to be assembled through insertion. In the case of an interlocked fitting form, a hook groove is provided in the outer side surface of the trigger base 61, and the two sets of trigger bases 61 make it possible for the outer contour of the trigger module 600 to be assembled through interlocking. It needs to be noted that, the trigger member 62 is transversely disposed relative to the base body 100, and the trigger member 62 is exposed outward relative to a trigger cavity, to facilitate sensing of a change in an external temperature and sensitive triggering.

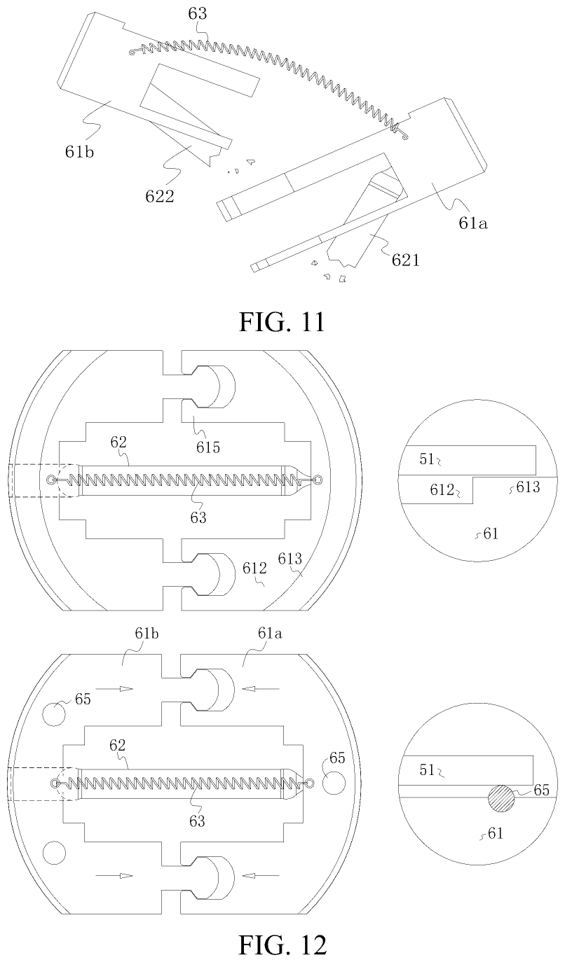

In addition, the impact of a position relationship between the trigger member 62 and the trigger base 61 on the triggering sensitivity of the trigger module 600 is described as follows. The trigger member 62 is disposed on the outer side of the trigger base 61; or the trigger member 62 is disposed inside the two sets of trigger bases 61, a through cavity is provided in the trigger base 61 relative to the trigger member 62, and the through cavity makes the trigger member 62 contact an external environment. Referring to FIG. 11 in the specification, a lateral through cavity 617 is disposed on the trigger module 600. For example, two lateral through cavities 617 are respectively disposed on two sides of the trigger member, and are used for the trigger member to sensitively sense the external temperature. When the temperature of the external environment reaches a trigger temperature of the trigger member 62, the trigger member 62 is triggered. In addition to the lateral through cavity 617, a bottom through cavity may be further disposed. A first bottom through cavity 616a and a second bottom through cavity 616b are disposed on the trigger module 600.

It needs to be noted that, when the through cavity is disposed, the weight of the trigger module 600 is reduced, the through cavity communicates the trigger member 62 with the outside to facilitate temperature sensing, and the lateral through cavity 617 is disposed to divide the original connecting portion 615 into an upper connecting portion 6151 and a lower connecting portion 6152, so that a thickness by which the two sets of trigger bases are connected to each other is kept from being excessively large, and a connecting portion between the two sets of trigger bases can be allowed to tilt relative to each other (which also makes the overall force bearing of the trigger module 600 uniform). In other words, when the two sets of trigger bases fold to each other, no jamming occurs between the two sets of trigger bases even if the two sets of trigger bases are not completely translated and folded, to ensure that the trigger base is smoothly folded into a detachable range.

It needs to be emphasized that for a contact manner between the trigger base 61 and the balance plate 51, the trigger module 600 and the base body 100 are threadedly connected, that is, a thread needs to be processed on the outer side surface of the two sets of trigger bases 61. Therefore, when an external thread is processed on the trigger bases 61 one by one, the fitness of the threads of the two sets of trigger bases 61 is slightly weak. There may be a misalignment problem between a first trigger thread 611a and a second trigger thread 611b. That is, there is unsmooth transition from the first trigger thread 611a to the second trigger thread 611b, causing unsmooth screwing of the trigger module 600 on the base body 100.

Based on the discovery and knowledge of the foregoing problems, referring to FIG. 12, the two sets of trigger bases 61 are relatively movable in the reference direction Z, to make the two sets of trigger bases 61 more flexibly fit the freely tiltable balance plate 51, so that the balance plate 51 can adaptively tilt along with the adjustment of the trigger base 61 in the reference direction Z. For example, the two sets of trigger bases 61 are vertically misaligned, to make trigger threads between the two sets of trigger bases 61 fit. It may be understood that, to improve the fitness between the balance plate 51 and the trigger base 61, an opposite protrusion is disposed on at least one of the balance plate 51 and the trigger base 61 at the contact surface between the two, and the protrusion is used as a contact site, to reduce a contact area, so that the adjustment between the two sets of trigger bases 61 is freer.

Referring to FIG. 12, in an embodiment, a concave groove 612 is provided at the exposure opposite end 600B of the trigger module 600 corresponding to the balance module 500, to make a contact portion 613 of the exposure opposite end 600B becomes the opposite protrusion. In another embodiment, the protrusion is a third bulb body 65. The third bulb body 65 is disposed on the trigger base 61 or the balance module 500, and the third bulb body 65 is rotatable in the trigger base 61 or the balance module 500. It needs to be particularly noted that the third bulb body 65 is freely rollable on the trigger base 61 or the balance module 500, so that the movement between the trigger base 61 or the balance module 500 is changed into a slide, thereby reducing a frictional force, to implement easy folding between the two sets of trigger bases 61. Specifically, at least one third bulb body 65 is disposed at a lower end of each trigger base 61. For example, one third bulb body 65 is disposed at a bottom portion of the first trigger base 61a, and two third bulb bodies 65 are disposed at a bottom portion of the second trigger base 61b. Certainly, the third bulb body 65 is simplified into a wheel body, which also fall within the general meaning of the third bulb body 65.

It may be understood that, the protrusion is preferably disposed at a periphery of a contact surface between the balance module 500 and the trigger base 61. In a case of fitting the tilt of the balance module 500, a space for adjusting the trigger base 61 in the reference direction Z is enlarged. If the protrusion is disposed at an inner edge of the contact surface between the balance module 500 and the trigger base 61, there is still a space for adjusting the trigger base 61 in the reference direction Z.

To prevent the sprinkler from being assembled and disassembled a second time and achieve the technical effect that it is not easy to detach the sprinkler after assembly, specifically, referring to FIG. 16, the trigger module 600 is spirally connected to the base body 100, and an outer side surface of the trigger module 600 is at least partially located in the base cavity 13. In another aspect, a penetrating communication groove 17 is provided in the base body 100 relative to the trigger module 600, and the communication groove 17 exposes the outer side surface of the trigger module 600 located in the base cavity 13. A fastening member 64 is disposed on the outer side surface of the trigger module 600 relative to the communication groove 17, the fastening member 64 is located in the communication groove 17, a movement range of the fastening member 64 is limited by a groove wall of the communication groove 17, and the fastening member 64 and a fastening groove 614 fit to limit rotation of the trigger module 600 relative to the base body 100.

A corresponding anti-disassembly and assembly process is different from conventional assembly.
S1: The trigger module 600 is threadedly connected on the base body 100, and after spiral connection, a partial external surface of the trigger module 600 is exposed relative to the communication groove 17 of the base body 100.
S2: The fastening member 64 is fastened on an external surface of the trigger module 600 exposed in a region of the communication groove 17. A specific fastening form of the fastening member 64 may be soldering, or lamination, or may be bonding.

In addition, to improve an anti-disassembly effect, the fastening groove 614 is provided in the outer side surface of the trigger module 600 opposite to the fastening member 64. For example, the fastening groove 614 is the concave groove 612, and the fastening member 64 is a steel ball. The steel ball is placed and fastened in the fastening groove 614, so that the connection strength between the steel ball and the trigger module 600 is higher than that of directly fastening the steel ball on a surface of the trigger module 600. Specifically, to increase a correspondence degree between the fastening groove 614 and the communication groove 17 of the base body 100, the trigger module 600 and the base body 100 may be first assembled, and then the fastening groove 614 is processed in the outer side surface of the trigger module 600 through the communication groove 17. After the fastening groove 614 has been processed, then the fastening member 64 is fastened in the fastening groove 614.

For the further use of the communication groove 17, an opening is further provided at the exposure end 600A of the communication groove 17 facing the trigger module 600, and the opening makes it possible to sleeve the communication groove 17. When there is a wrench (not shown in the figure) of a special type, the wrench is sleeved on the base body 100, and convex teeth on the wrench are clamped in the communication groove 17, so that the communication groove 17 is used as a buckling opening, thereby facilitating rotatable connection and disassembly between the base body 100 and the firefighting piping network.

A water distribution module 400, referring to FIG. 9 and FIG. 10, is used for uniformly distributing water after the sprinkler is triggered. The water distribution module 400 is disposed in the base cavity 13. The water distribution module 400 includes a water distribution tray 41 and a guide rod 42. The water distribution tray 41 is disposed as an intermediate force transfer member between the sealing module 200 and the trigger module 600, or a channel is provided in the water distribution tray 41, and the channel makes the trigger module 600 act on the sealing module 200. The guide rod 42 is located near a wall of the base cavity 13, to reserve a central region of the base cavity 13. The guide rod 42 and the base body 100 are movably connected, or the guide rod 42 is extensible, to make the guide rod 42 movable toward the outside of the base body 100. In a case that the guide rod 42 and the water distribution tray 41 are connected, after the trigger module 600 is triggered, the water distribution tray 41 protrudes outside the base body 100 along with the guide rod 42, to get ready for uniform water distribution.

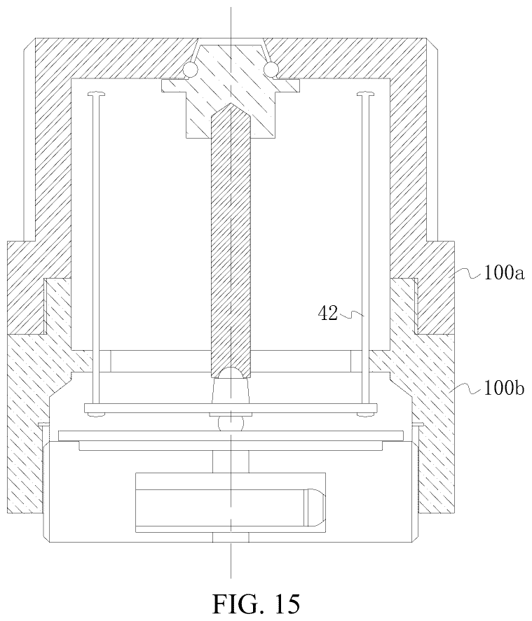

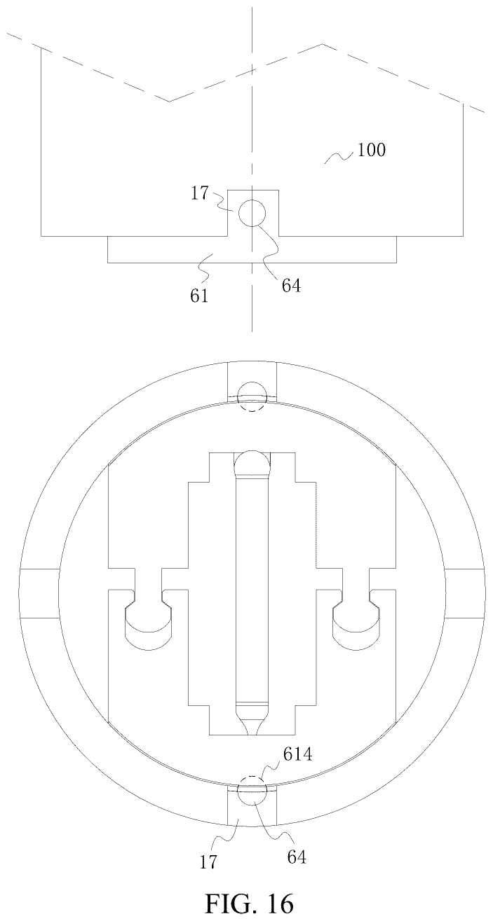

Specifically, a connection form between the guide rod 42 and the base body 100, referring to FIG. 5, may be that a clamp ring 15 is disposed in the base cavity 13. The guide rod 42 passes through and is limited in the clamp ring 15. The base body 100 and the guide rod 42 are movably connected by the clamp ring 15. Certainly, in addition to the clamp ring 15, another connecting member may further be disposed between the base cavity 13 and a guide member. The another connecting member and the base cavity 13 may be clamped, or may be inserted, fastened, magnetically attracted, among other manners. In addition, the connecting member may be a part of the base body 100. Referring to FIG. 15, the base body 100 is separately disposed, and the base body 100 is classified into a first base body 100a and a second base body 100b. A separate design makes it convenient to process a connecting member part on the base body 100. The connecting member part may be disposed in the second base body 100b, or may be disposed on the first base body 100a.

When the water distribution module 400 is disposed on the sprinkler, a connection form between the balance module 500 and the water distribution module 400 is described. Referring to FIG. 14, there are specifically three forms:

In the first form, the water distribution tray 41 and the sealing main body 21 of the sealing module 200 are integrally connected, and the second bulb body 52 abuts against the water distribution tray 41, to tightly press the sealing module. If the sealing main body 21 is connected to the water distribution tray 41 through insertion or sleeving and a part of the sealing main body 21 passes through a lower end surface of the water distribution tray 41, the second bulb body 52 may directly abut against the sealing main body 21. It needs to be particular noted that in the foregoing first case, after the sprinkler is triggered, the sealing module remains fastened to the water distribution tray, and there is still a very large space for a water flow in the piping network to move out of the base cavity 13 to be uniform distributed on the water distribution tray 41.

In the second form, the water distribution tray 41 is disposed between the sealing module 200 and the trigger module 600, and a force is transferred through leveled abutting. If the balance module 500 exists, the water distribution tray 41 is disposed between the sealing module 200 and the balance module 500, the second bulb body 52 in the balance module 500 abuts against the water distribution tray 41, and then the water distribution tray 41 abuts against the sealing module 200. In addition, the balance module 500 separately contacts the water distribution tray 41 and the trigger module 600.

In the third form, the water distribution tray 41 is provided with an avoidance channel 412 to reserve a space, and does not participate in force transfer between the trigger module 600 and the sealing module 200. If the balance module 500 exists, the balance module 500 is located between the sealing module 200 and the trigger module 600, and the balance module 500 passes through the avoidance channel 412 of the water distribution tray 41 to abut against the sealing module 200. For example, the balance module 500 includes the balance plate 51 and the second bulb body 52. The balance plate 51 is located below the water distribution tray 41, the second bulb body 52 is located on the balance plate 51, and the second bulb body 52 passes through a channel/through hole of the water distribution tray 41 to abut against the sealing module 200. It may be understood that, in the foregoing several cases, the sealing module 200, the water distribution module 400, and the balance module 500 are all preferably distributed and disposed along a central line, to implement stable force transfer without a deviation.

It needs to be noted that, when the water distribution module 400 is placed, to enable the water distribution tray 41 to move below the base body 100, the guide rod 42 needs to have a particular length (or the guide rod 42 may be disposed as an extensible rod). It means that a space of the base cavity 13 needs to be long enough. A space to be filled appears between the balance module 500 and the sealing module 200, and a vertical rod 300 may be disposed to support the space to be filled.

For the vertical rod 300, refer to FIGS. 9 and 10. The vertical rod 300 is used as an intermediate member for force transfer. To enable the vertical rod 300 to transfer a force more stably, a bearing groove 312 is preferably provided in the vertical rod 300. The bearing groove 312 fits a first bulb body 32, to allow the vertical rod 300 to shake in a particular range. The first bulb body 32 is disposed on a side of the vertical rod 300 opposite to the sealing module 200 or a side of the vertical rod 300 opposite to the balance module 500/the water distribution module 400. For example, the vertical rod 300 includes a rod head 311 and a rod tail. The rod head 311 is inserted in the sealing module 200, the bearing groove 312 that is concave inward is provided in the rod tail, the first bulb body 32 is accommodated in the bearing groove 312, and the first bulb body 32 contacts the balance module 500.

In addition, referring to FIG. 9, in an embodiment, the water distribution tray 41 is disposed between the sealing module 200 and the balance module 500. The water distribution tray 41 is divided into a tray body and the guide rod 42 that connects the tray body and the base body 100, and the water distribution tray 41 and the sealing module 200 are attached or connected (refer to FIG. 2 in the specification). Certainly, the water distribution tray 41 is disposed below the trigger module 600, and it is also feasible to arrange a connecting arm to connect the water distribution tray 41 and the base body 100. Certainly, the water distribution tray 41 may further be used as the balance plate 51. In a first state, the water distribution tray 41 is located in the trigger cavity, and the water distribution tray 41 is used for bearing a pressure between the trigger module 600 and the sealing module 200. In a second state, the water distribution tray 41 is located outside the trigger cavity and used for distributing water.

In addition to the foregoing parts of the sprinkler, to increase the fitness during actual assembly of the sprinkler, a cover body 700 is further fit on the sprinkler.

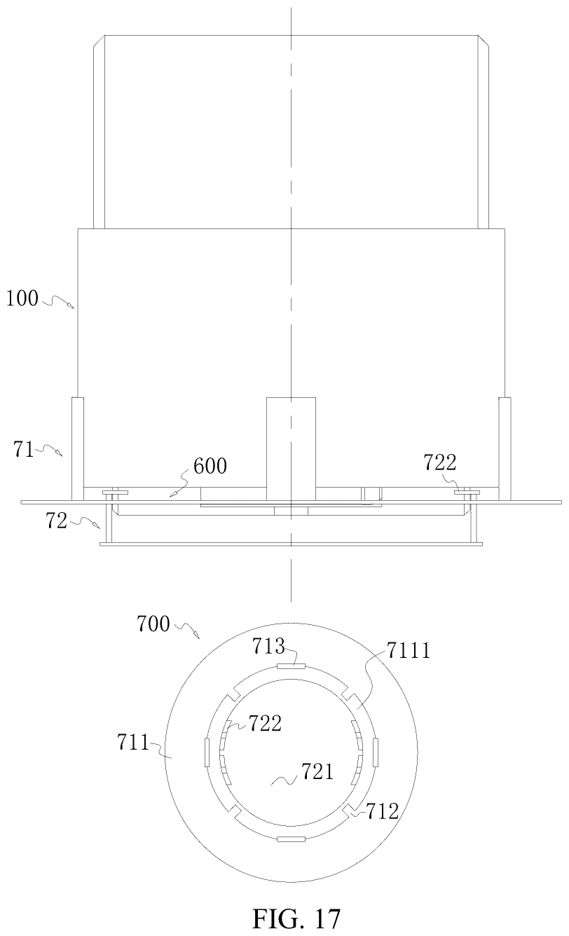

The cover body 700, referring to FIG. 17, is used for protecting the trigger module and the aesthetic value of mounting the sprinkler. The cover body 700 includes an external cover 71 and an inner cover 72. An inner cavity 7111 is provided in the middle of the external cover 71. A plurality of external cover claws 713 are disposed at an edge of the inner cavity 7111. The plurality of external cover claws 713 form one clamping cavity of the external cover 71 clamped at an outer side surface of the base body 100. Preferably, a convex limiting block 712 is disposed at the edge of the inner cavity 7111, and the limiting block 712 limits a movement range of the external cover 71 in an axial direction of the sprinkler. A plurality of inner cover claws 722 are disposed on the inner cover 72. The plurality of inner cover claws 722 form one clamping cavity of the inner cover 72 clamped at a side surface of the exposure end 600A of the trigger module 600. A contour size of the inner cover 72 is smaller than a size of the inner cavity 7111 of the external cover 71, and the inner cover 72 is approximately located in a projection of the clamping cavity of the external cover 71 in the axial direction of the sprinkler.

It needs to be particularly noted that, a force-applying direction of clamping the trigger module 600 by the inner cover claws 722 is the first direction (specifically, two sets of inner cover claws 722 are disposed, and the two sets of inner cover claws 722 respectively act on the two sets of trigger bases 61, to respectively drive the two sets of trigger bases 61). A movement direction (that is, the folding direction) in which the two sets of trigger bases 61 are combined with each other is the second direction. It is designed that the first direction and the second direction are approximately same. That is, in the force-applying direction of the inner cover claws 722 on the trigger module 600, the two sets of trigger bases 61 may be pushed to fold to each other, to promote the triggering stability of the trigger module 600.

In addition, a through hole may be further provided in an inner cover main body 721 to improve air permeability, to enable the trigger member 62 to sensitively sense a temperature change in a surrounding environment; and the inner cover main body 721 may further protect the trigger member 62, to keep a foreign object from directly hitting the trigger member 62.

### Trigger Principle

Referring to FIG. 9 and FIG. 10, when an environmental temperature rises, the trigger member 62 senses the temperature and is triggered (it is shown in the figure that the trigger member 62 is the temperature-sensing glass bulb, that is, the temperature-sensing glass bulb fractures). Based on an inclined surface of a threaded structure, the trigger base 61 generates a first component force F1a toward the center of the trigger module 600 to make the two sets of trigger bases 61 fold to each other (or a force of the elastic member 63 and/or the inner cover 72 on the trigger base 61), the trigger base 61 is detached from the base cavity 13. After the trigger base 61 is detached from the base cavity 13, the balance module 500 is detached. If the water distribution module 400 exists, the water distribution module 400 drops, and the water distribution tray 41 is located below the base body 100. Subsequently, if the vertical post exists, the vertical post is also detached. Finally, the sealing module 200 is detached, and a water flow in the firefighting piping network strikes down on the water distribution tray 41 along the sealing opening 12, to perform firefighting work.

### Beneficial Effects

1. The trigger module 600 with the elastic member 63 is designed. The position of the elastic member 63 in the trigger module 600 is appropriately designed, so that when the trigger member 62 in the trigger module 600 is triggered, two trigger bases 61 that are combined together are forcefully retracted under the action of the elastic member 63. In this way, the trigger module 600 has fast response. In addition, a retraction action of the trigger base 61 is accelerated, which is conducive to prevent fragments of the trigger member 62 in bursting and fracturing from getting stuck between the sets of the trigger bases 61 that quickly fold and close. In addition, under the action of the elastic member 63, the movement capacity of the trigger base 61 is enhanced, and it is conducive to cope with rust between the trigger base 61 and the base body 100, rust between the two sets of trigger bases 61, and rust at other connections as well as garbage and foreign matter accumulation.
2. Because the trigger member 62 is not directly subjected to a water pressure in a piping network, the trigger member 62 only limits the stability of the outer contour of the trigger module 600, and has a low requirement on a specific position of the trigger member 62 in the trigger module 600, that is, has low requirements of assembly capacity and precision of parts, and the assembly effect of the trigger member 62 can be quickly determined by shaking the trigger module 600. The technical problem of how to simplify the assembly process of the sprinkler in the prior art is resolved, to achieve the technical effect of simplifying the assembly process of the sprinkler.
3. A threaded connection is designed between the trigger module 600 and the trigger substrate 16, to ensure the assembly precision between the trigger module 600 and the trigger substrate 16, so that the trigger module 600 can tightly press the sealing module 200 in a screwed manner according to an ideal state. In a first aspect, spiral tight pressing makes the trigger module 600 move along a central line in a tight pressing process, to prevent axial shaking of the trigger module 600 from causing deviation and friction between the sealing module 200 and the base body 100, thereby ensuring the reliability of sealing the sealing opening 12 by the sealing module 200. In a second aspect, for spiral tight pressing, the assembly is convenient, and the connection has high stability, which is conducive to reduce connection heights of the base body 100 and the trigger module 600 in the sprinkler based on high stability of a threaded connection, and reduce a height of the entire sprinkler. In a third aspect, a spiral connection can effectively resolve a force F1 of the sealing module 200 in a deformed state to obtain a first component force F1a that makes the trigger base 61 move centripetally.
4. After several trigger bases 61 are designed to be initially associated with each other, the trigger member 62 abuts against the trigger base 61 in combination, to make the trigger module 600 into an independent assembly unit, which facilitates assembly operation step by step, and is conducive to increase assembly efficiency and increase quarantine inspection efficiency. The stability is higher during transportation, to prevent shaking and falling apart to cause triggering of the sprinkler by mistake.
5. The water distribution tray 41 is added between the sealing module 200 and the balance module 500, the water distribution tray 41 and the sealing module 200 are combined into a small assembly unit, the water distribution tray 41 and the sealing module 200 are first assembled, and then the water distribution tray 41 is mounted on the base body 100. Certainly, the water distribution tray 41 and the sealing module 200 may be independent of each other, to implement force transfer through abutting. In an external sprinkler structure of a conventional water distribution tray 41, the trigger module 600 of this application is also applicable, which is conducive to reduce the assembly difficulty of a conventional sprinkler, thereby reducing labor.
6. The trigger member 62 is transversely disposed. The trigger member 62 is not directly subjected to a water pressure in the firefighting piping network, and is only subjected to a small force for maintaining the form of the trigger module 600. Therefore, a glass bulb with a small size or soldered connection or filling of a fusible alloy may be selected for the trigger member 62, to make the size of the entire sprinkler decrease. In addition, the quantity/sizes of parts are further reduced, and the feedback of forces is more direct and quicker, thereby increasing a response rate and further reducing a fault rate.
7. A solution of threaded processing precision between the two sets of trigger bases 61 is conceived, and a structural relationship between the balance module 500 and the trigger module 600 is redesigned. Specifically, the second bulb body 52 is used to implement free tilting of the balance plate 51, and in combination, the balance plate 51 and the trigger base 61 contact by a small area, so that when the trigger module 600 and the base body 100 are screwed, the two sets of trigger bases 61 can be slightly adjusted in the reference direction Z, and an error of a thread fit between the two sets of trigger bases 61 is compensated, thereby ensuring that force transfer between the trigger base 61 and the balance plate 51 remains stable.
8. The overall structural distribution of the sprinkler is redesigned. The water distribution module 400 is disposed in the base cavity 13 of the base body 100. Specifically, an intermediate force transfer member solution and a channel avoidance solution are conceived between the water distribution module 400 and the sealing module 200 and the trigger module 600, and a separate design of the base body 100 facilitates a connection with the guide rod 42 of the water distribution module 400, or the clamp groove 14 and the clamp ring 15 are disposed on the base body 100 to connect to and limit the movement range of the guide rod 42.
9. The communication groove 17 exposing the trigger module 600 is provided in the base body 100, the fastening member 64 is disposed in a region of the trigger module 600 corresponding to the communication groove 17, and the fastening member 64 is partially located in the communication groove 17, to keep the trigger module 600 from rotate by a large extent, thereby ensuring that the trigger module 600 cannot be disassembled, and avoiding the problem that the sprinkler is disassembled and assembled a second time after delivery.

Although some exemplary embodiments of the present invention have been described, persons skilled in the art can make changes and modifications to these embodiments once they learn the basic inventive concept. Therefore, the following claims are intended to be construed as to cover the exemplary embodiments and all changes and modifications falling within the scope of the present invention.

Obviously, a person skilled in the art can make various modifications and variations to the present invention without departing from the spirit and scope of the present invention. In this case, if the modifications and variations made to the present invention fall within the scope of the claims of the present invention and their equivalent technologies, the present invention is intended to include these modifications and variations.

1. A trigger module, fitted on a base body of a sprinkler, and comprising:
a trigger base, wherein two sets of trigger bases are disposed, and the two sets of trigger bases form an outer contour prototype of the trigger module; and
a trigger member, wherein two ends of the trigger member are respectively connected to the two sets of trigger bases; or the trigger member abuts between the two sets of trigger bases, to limit the two sets of trigger bases from moving toward each other,
wherein when the trigger member is in a triggering state, the two sets of trigger bases move toward each other, to make an outer contour of the trigger module shrink.

2. The trigger module according to claim 1, wherein if the trigger member abuts between the two sets of trigger bases, the outer contour prototype of the trigger module formed by combining the two sets of trigger bases has an extension range; or the two sets of trigger bases are independent of each other, and a maximum value of a size of the outer contour of the trigger module is limited by the base body of the sprinkler.

3. The trigger module according to claim 1, wherein the trigger member adjustably abuts between the two sets of trigger bases, and an abutting size of the trigger member is adjusted to make the trigger member abut the two sets of trigger bases in a state that the size of the outer contour of the trigger module is the maximum value.

4. The trigger module according to claim 1, wherein the trigger base further comprises a connecting portion, and the connecting portion acts on the two sets of trigger bases to limit the two sets of trigger bases from moving away from each other.

5. The trigger module according to claim 4, wherein the connecting portion and the trigger base are integrated, connecting portions of the two sets of trigger bases are interlocked; or the connecting portion and the trigger base are separately disposed, and the connecting portion and the trigger base are interlocked, or two sets of connecting portions are interlocked.

6. The trigger module according to claim 4, wherein the connecting portion is a ring-shaped body, and the connecting portion is sleeved between the two sets of trigger bases.

7. The trigger module according to claim 1, wherein the trigger member comprises:
a connecting plate, located between the two sets of trigger bases; and
a fusible alloy, connecting the connecting plate and the trigger base;
or the trigger member comprises:
a fusible alloy, abutting between the two sets of trigger bases;
or the trigger member comprises:
a temperature-sensing glass bulb, transversely disposed between the two sets of trigger bases; and
a fastening member, disposed on a trigger base, wherein the fastening member abuts against the temperature-sensing glass bulb, and the fastening member makes the temperature-sensing glass bulb abut between the two sets of trigger bases.

8. The trigger module according to claim 1, wherein the two sets of trigger bases are subjected to an external force and have a tendency to move toward each other; or the trigger module further comprises an elastic member, and the elastic member acts on the trigger bases to make the two sets of trigger bases have a tendency to move toward each other.

9. The trigger module according to claim 1, wherein a connecting force-bearing surface on an outer side of the trigger base is at least partially an inclined surface, and the inclined surface makes the trigger module subjected to a component force of a force driving the outer contour to fold.

10. The trigger module according to claim 1, wherein a trigger thread is disposed on an outer side surface of the trigger base, and the trigger thread has a force-bearing inclined surface.

11. A sprinkler, comprising:
a base body, comprising a sealing opening, a base cavity, and a trigger substrate;
a sealing module, located in the base cavity, and sealing the sealing opening; and
the trigger module according to claim 1, wherein the trigger module is partially or completely located in the base cavity, the trigger module abuts against the sealing module and limits a position of the sealing module, the trigger module is connected to the trigger substrate by an outer contour, after a trigger member is triggered, the outer contour of the trigger module shrinks, and a connection between the trigger module and the trigger substrate fails to make the trigger module detached from the base cavity.

12. The sprinkler according to claim 11, wherein a balance module is disposed between the sealing module and the trigger module, the balance module and the sealing module contact at a central point, and the balance module makes the trigger module apply a pressure to the sealing module.

13. A sprinkler, wherein the sprinkler comprises a base body, a sealing module, and a trigger module, and the sealing module seals a sealing opening in the base body; the trigger module according to claim 1, the trigger module comprises two trigger bases combined together, two sets of trigger bases are combined to form a prototype of the trigger module, and the two sets of trigger bases are relatively movable in a reference direction; and
the sprinkler further comprises: a balance module, located between the sealing module and the trigger module, and separately contacting the sealing module and the trigger module,
wherein the balance module is tiltable relative to the trigger module; and an opposite protrusion is disposed on at least one of the balance module and the trigger base at a contact surface between the two, and the protrusion and the tiltable balance module make the two sets of trigger bases adjustable in the reference direction.

14. A sprinkler, comprising a base body having a base cavity, a sealing module located in the base cavity, a balance module located in the base cavity, and a trigger module located in the base cavity, wherein the sealing module seals a sealing opening in the base body, and the trigger module abuts the sealing module through the balance module; and the sprinkler further comprises:
a water distribution module, comprising:
a water distribution tray, disposed in the base cavity, wherein the water distribution tray and the sealing module are integrally connected, and the balance module acts on the water distribution tray or the sealing module; or the water distribution tray is disposed between the sealing module and the balance module, and the balance module, the water distribution tray, and the sealing module sequentially abut; or the water distribution tray is disposed between the sealing module and the balance module, a avoidance channel is provided in the water distribution tray, and the balance module passes through the avoidance channel to act on the sealing module; and
a guide rod, wherein the guide rod and the base body are movably connected, or the guide rod is extensible, and the guide rod and the water distribution tray are connected, so that after the trigger module is triggered, the water distribution tray protrudes outside the base body.

15. A sprinkler, comprising a base body having a base cavity, a sealing module located in the base cavity, and a trigger module located in the base cavity, wherein the sealing module seals a sealing opening in the base body, the trigger module according to claim 1, the trigger module comprises two sets of trigger bases, and the two sets of trigger bases are combined to form a prototype of the trigger module; and the trigger module is connected to the base body by an outer contour, the trigger module abuts against the sealing module and limits a position of the sealing module, and an outer side surface of the trigger module is at least partially located in the base cavity; and
a penetrating communication groove is provided in the base body relative to the trigger module, and the communication groove exposes the outer side surface of the trigger module located in the base cavity,
wherein a fastening member is disposed on the outer side surface of the trigger module relative to the communication groove, the fastening member is located in the communication groove, and the fastening member and a fastening groove fit to limit rotation of the trigger module relative to the base body.

16. A sprinkler, wherein an outer side surface of a trigger module is at least partially exposed outside a base cavity, the sprinkler is further provided with a cover body, and the cover body comprises:
an inner cover, wherein an inner cover claw is disposed in the inner cover, two sets of inner cover claws are clamped at an exposed part of the trigger module opposite to the base cavity, a force-applying direction of the inner cover claws on the trigger module is a first direction, and the trigger module comprises two sets of trigger bases, the two sets of trigger bases are combined to form a prototype of the trigger module, a movement direction in which the two sets of trigger bases fold to each other is a second direction, and the first direction and second direction are approximately same, to make an outer contour of the trigger module have a tendency to fold.
